(19) United States
(12) Patent Application Publication
(10) Pub. No.: US 2006/0032846 A1
(43) Pub. Date: Feb. 16, 2006

(54) Infrared heating element and a substrate type vacuum chamber, particularly for vacuum coating facilities

(76) Inventor: Dieter Haas, Brunchkobel (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/186,326

(22) Filed: Jul. 21, 2005

(30) Foreign Application Priority Data
Jul. 27, 2004 (EM) 04 017 775.0

(51) Int. Cl. H05B 3/10

(52) U.S. Cl. 219/553

(57) ABSTRACT

The present invention relates to an infrared heating element and a substrate heater type vacuum chamber, particularly for vacuum coating facilities. The infrared heating element comprises a heating source which is surrounded by a protective means designed as a tubular metal jacket. The tubular metal jacket is provided at least to an extent with an infrared-emitting layer. The vacuum chamber comprises a substrate and at least one heating element that is designed as an infrared heating element, the substrate and infrared heating element being thermally decoupled in such a way that only thermal radiation contributes toward heating.

### BACKGROUND AND TECHNICAL FIELD OF THE INVENTION

The invention relates to an infrared heating element and a substrate heater type vacuum chamber, particularly for vacuum coating facilities, in accordance with the preamble of claim 1 and claim 10.

Heat can be transferred spatially as a result of thermal conduction, thermal radiation and thermal convection. Whereas thermal conduction occurs by way of molecular collisions and hence requires a temperature gradient in matter, thermal convection depends on macroscopic movements in liquids or gases, the heat content of which is conveyed to other points. Thermal radiation is electromagnetic in nature.

The substrate cannot be heated directly by thermal conduction as regards certain processes. For example, the substrate can be attached to a movable substrate holder (carrier) which moves the substrate through various process chambers. It is hard to equip this kind of carrier with a heating plate, such as a BN resistance substrate heater. What are needed here are electrical sliding contacts which carry current and generate particles possibly as a result of abrasion. In the field of sputter cathodes, secondary plasmas, which can interfere with the plasma discharge from the sputter cathodes or give rise to flashovers, may be produced at the live contacts. Particles that are deposited on the substrate may lead to “pinholes”, in that such particles fall off the substrate after it has been coated, or remain on the substrate as a defect in a functional layer. Furthermore, it requires a great deal of time and effort to produce contact surfaces for a heating plate which has such a smooth and level surface as to ensure the transfer of heat to the substrate over the entire surface area. If only localized points on the substrate lie on the heating surface, a sensitive substrate may be destroyed by thermal stresses because the vacuum does not contain any contact medium that produces the heat transfer, such as atmospheric air. In addition, it would be necessary to make a customized heating surface for every type of substrate; in this case, such a heating surface would also have to be rendered scratchproof or dirt-repellent.

The substrate can be conveyed either horizontally on the substrate holder or in a vertical (i.e. upright) position. The substrate is inserted within a frame or trestle and is held by means of springs, whereby the substrate holder (carrier) moves on rollers at its lower end and is magnetically held in position at its upper end. This manner of substrate conveyance is described in CH 691 680 A, for example.

On the other hand, it is, moreover, conceivable, especially in the case of large-area substrates, to convey the substrate through the vacuum unit via a conveying system consisting of, for example, rollers. In this case, too, it is not possible to heat the substrate by way of thermal conduction, because the substrate is exposed.

If thermal conduction is not possible in a vacuum, the only option is to transfer heat by thermal radiation. The energy distribution of thermal radiation is described by means of the ideal black-body radiator and Planck's radiation law applies. This law describes the black body's spectral energy distribution with an energy maximum and low radiant energies for very low and very high wavelengths of radiation.

On account of its larger wavelength (λ>0.75 μm), infrared radiation is absorbed by materials much more effectively than radiation in the range of visible light (0.4 μm<λ<0.75 μm). This absorption in the infrared spectral range is attributable to vibrations of the ions within the materials. Thermal radiators are frequently used to generate infrared radiation. Infrared heating elements are therefore devices which, when heat acts thereon, emit thermal radiation in the infrared spectral range.

The problem with such thermal radiators is that apart from infrared radiation, radiation in the visible and ultraviolet ranges is always emitted. As a result, the transferred heating capacity is limited compared to that which is radiated in total. In accordance with Planck's radiation law, the maximum energy distribution and the total energy density of a black body is dependent only on its temperature and can be described by Wien's displacement law (νₘₐₓ˜T) or the Stefan-Boltzmann (fourth-power) law (R=σT⁴, σ being a constant). The relation between a real thermal radiator and a black body is described by the emittance ε (0≦ε≦1, 1 corresponding to an ideal black body), so it follows that R=εσT⁴.

### SUMMARY OF THE INVENTION

The object of the present invention is to make available an infrared heating element which transfers heat very effectively as a result of thermal radiation, particularly in a vacuum. A further object of the present invention is to provide a substrate heater, particularly for vacuum coating facilities, which permits a substrate to be heated very effectively by means of thermal radiation. In this context, the term “effective” means on the one hand that the ratio of the total energy emitted to the thermal radiation energy used for heating is optimized, in other words, losses are reduced. On the other hand, however, the aim is also to minimize the temperature of the heating element compared to the temperature reached by the object to be heated.

As specified by the invention, the aforementioned objects are solved by an infrared heating element according to claim 1 and by a substrate heater according to claim 21. Advantageous embodiments of the invention are characterized by the features described in the dependent claims.

### BRIEF DESCRIPTION OF THE DRAWINGS

FIG. 1 is a sectional view of one embodiment of a substrate heater according to the present invention.

### DESCRIPTION OF THE PREFERRED EMBODIMENT

The infrared heating element according to the invention comprises a heating source that is surrounded by a protective means designed as a tubular metal jacket. The tubular jacket is coated at least to an extent with an infrared-emitting layer. The heating source sheath in the form of a tubular metal jacket not only protects the heating source, but also brings about an even distribution of heat as a result of thermal conduction within the tubular jacket. The fact that the tubular jacket is coated at least in part with an infrared-emitting layer increases the effectiveness of thermal radiation and enables the jacket temperature to drop while retaining the radiated thermal energy.

It is beneficial for the metal to have an emittance of between 0.1 and 0.4 and for the infrared-emitting layer to have an emittance of more than 0.7, preferably of more than 0.8 and particularly of more than 0.9. Such an infrared-emitting layer approximates a black body very closely in terms of its spectral energy distribution. In this case, the tubular jacket itself does not serve to radiate heat, but heats the infrared-emitting layer by way of thermal conduction.

It is expedient for the heating source to be designed as a resistance heater in the form of a heating wire, made of tungsten for instance. Whereas high-grade steel or the high-temperature-resistant alloy Inconel® is preferably used as a material for the tubular metal jacket, the use of a metal oxide is recommended for the infrared-emitting layer. These metal oxides are known to be excellent infrared emitters. It is expedient to use TiO₂ as a metal oxide. Such a metal oxide layer is applied particularly well to the tubular jacket if plasma spraying is used, but sputtering is also possible. In this way, thin even layers with a thickness from about 10 nm up to several millimetres can be applied.

The radiation characteristic exhibited by the infrared heating element can be influenced in that only those regions of the tubular jacket are coated with an infrared-emitting layer which are intended to contribute toward infrared radiation. Certain solid angles are consequently not exposed to intense infrared radiation, but only to the radiation of the tubular jacket, which is lower in the infrared spectral range than that of the infrared-emitting layer. The tubular jacket prevents direct energy radiation of the heating source into these solid-angle regions and part of this energy is thus used to heat the infrared-emitting layer as a result of thermal conduction within the tubular jacket. The efficiency of the infrared heating element can therefore be increased even further.

The substrate heater type vacuum chamber according to the invention comprises a substrate and at least one heating element which is positioned adjacent thereto and which is designed as an infrared heating element according to the invention, with the substrate and infrared heating element being thermally decoupled. In this context, thermal decoupling means that to the greatest possible extent, no thermal conduction or convection arises. Such thermal decoupling causes heating to take place only by way of thermal radiation emitted by the infrared heating element. For this reason, the substrate is heated very effectively via infrared radiation by means of the infrared heating element. Furthermore, heating can occur very selectively, because the substrate temperature is adjustable directly via the heating capacity of the infrared heating element.

It is expedient for the substrate heater to be insulated from the walls of the vacuum chamber by using a thermal insulator which is likewise thermally decoupled. In this way, heat losses can be avoided, and it is possible to prevent any unwanted heating; in particular, it is possible to prevent the walls of vacuum coating facilities from being heated.

The at least one infrared heating element is preferably positioned such that its longitudinal axis is aligned parallel to the substrate surface. The substrate can thus be heated very effectively.

It is advantageous for the tubular metal jacket of the at least one infrared heating element to comprise an infrared-emitting layer designed as a cylindrical longitudinal segment and for this segment to be positioned such as to point toward the substrate. Heating thus occurs in a manner that reduces losses, since only the substrate is exposed to intense infrared radiation.

The number of infrared heating elements is preferably chosen such that the substrate is exposed—as a function of the substrate surface to be heated, of the distance of the infrared heating elements and of their size—to infrared radiation in as even a manner as possible. The substrate is therefore heated evenly and hence largely without stresses.

As far as certain processes are concerned, the substrate must be attached to a movable substrate holder (carrier) which moves the substrate through various process chambers. The substrate is connected to the substrate holder in a known manner. In this instance, the substrate is likewise heated by the infrared heating element directly via thermal radiation. This may be brought about, for example, in that the substrate is conveyed in a vertical (i.e. upright) position on the substrate holder. In this case, the substrate, as it is conveyed through the facility, is heated from both sides so as to ensure uniform heating. Only in the area of coating stations is the substrate heated, on one side, from the rear which faces away from the coating side in order that the substrate temperature does not drop too much during coating.

Nevertheless, it is also possible to position the substrate heater on that side of the substrate holder which is opposite the substrate, or it is possible for the substrate holder to have large-area openings or the like or for it to be designed as a frame, thereby enabling the substrate to be exposed to thermal radiation on both sides in a manner which is even and covers a large area.

The substrate heater type vacuum chamber according to the invention can therefore be used to anneal the substrate easily, for example during coating processes if the substrate holder cannot be directly heated by thermal conduction on account of certain process parameters.

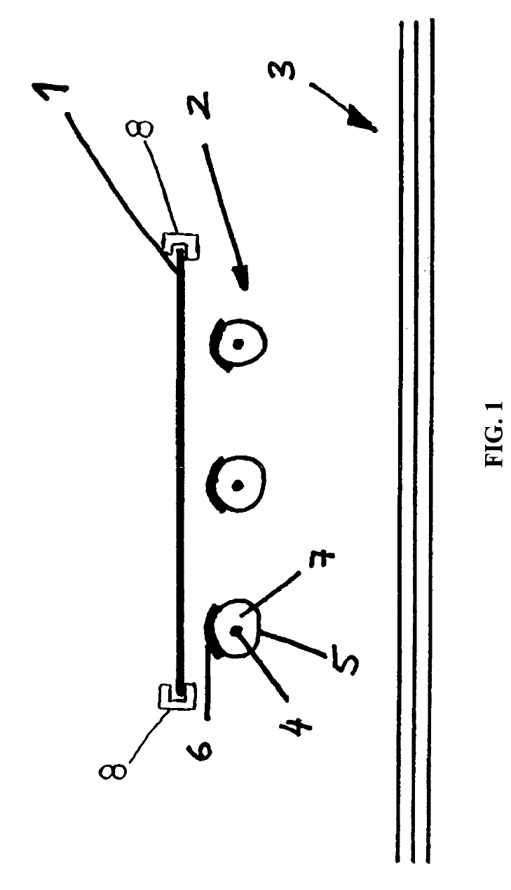

An exemplary embodiment will now be explained in more detail on the basis of FIG. 1. As illustrated, a substrate heater comprises a substrate 1, three infrared heating elements 2 and a thermal insulator 3. The infrared heating elements 2 are positioned in a thermally decoupled manner between the substrate 1 and the thermal insulator 3 at a distance of approximately 2 cm. The substrate 1 is held by the substrate holder 8. The thermal insulator 3 for thermally insulating the vacuum chamber comprises a set of three successively arranged reflective radiation plates. The plates have an emission coefficient of ε<0.1. By using these plates, which are not in thermal contact, in a vacuum, an exchange of thermal energy can take place only by means of thermal radiation. The thermal radiation of the plates is relatively low, however, on account of their small emission coefficient. If, for example, the first plate of the thermal insulator 3 is heated by the infrared heaters 2 to approximately 500° C., the second radiation plate only has a temperature of about 400° C., whereas the last plate, which is opposite the chamber wall, only has a temperature of 300° C.

Known tungsten heating wires 4 are used as heating sources of the infrared heating elements 2; these wires are supplied with current in a known manner and this supply of current is controlled by means of a control loop as a function of the substrate temperature that is to be set. The tungsten heating wires 4 are each enveloped by a compacted quartz sand filling 7 and tubular Inconel® jackets 5. The tubular jackets 5 are electrically insulated in relation to the respective tungsten heating wires 4. The tubular jackets 5 are provided with a TiO₂ layer 6 as an infrared-emitting layer on their surface which faces toward the substrate 1. The TiO₂ layer 6 is 100 μm thick and was applied to the tubular jacket 5 by means of plasma spraying. The coating can, however, also be applied by means of sputtering, in which case thinner layers in the range of 10 nm and over are preferred.

If the infrared heating elements 2 according to the invention are spaced 2 to 5 cm apart from the substrate 1, jacket temperatures of approximately 600° C. will be required for substrate temperatures in excess of 400° C. Compared to purely metallic jacket heaters in which jacket temperatures of over 850° C. are required for substrate temperatures in excess of 400° C., these jacket temperatures are far below the melting point of the metal jacket 5 (about 1,100° C.). The substrate heater according to the invention can therefore be used to reduce the jacket temperature to uncritical temperatures, and the losses are minimized when the substrate is heated by means of thermal radiation.

The embodiments of the invention in which an exclusive property right or privilege are claimed are defined as follows:

1. An infrared heating element for heating a substrate in a vacuum chamber, said infrared heating element comprising:
a heating source; and
a protective means, said protective means being designed as a tubular metal jacket;
wherein said tubular metal jacket sheathes said heating source and includes at least a partial infrared-emitting layer.

2. An infrared heating element according to claim 1, wherein said tubular metal jacket is constructed of a metal having an remittance of between 0.1 to 0.4 and said infrared-emitting layer has an emittance of more than 0.7.

3. An infrared heating element according to claim 2, wherein said infrared-emitting layer has an emittance of more than 0.8.

4. An infrared heating element according to claim 3, wherein said infrared-emitting layer has an emittance of more than 0.9.

5. An infrared heating element according to claim 2, wherein said heating source is designed as a heating wire of a resistance heater.

6. An infrared heating element according to claim 5, wherein said infrared-emitting layer comprises a metal oxide layer.

7. An infrared heating element according to claim 6, wherein said metal oxide layer comprises TiO₂.

8. An infrared heating element according to claim 7, wherein said TiO₂ layer has a thickness of between approximately 10 nm to 5 mm.

9. An infrared heating element according to claim 8, wherein said TiO₂ layer has a thickness of between approximately 50 nm to 500 μm.

10. An infrared heating element according to claim 9, wherein said TiO₂ layer has a thickness of between approximately 100 nm to 100 μm.

11. An infrared heating element according to claim 8, wherein said infrared-emitting layer is applied to said tubular metal jacket by plasma spraying.

12. An infrared heating element according to claim 11, wherein said tubular metal jacket comprises at least one selected from the group consisting of high-grade steel and Inconel®.

13. An infrared heating element according to claim 12, wherein said tubular metal jacket includes said infrared-emitting layer only in surface regions of said tubular metal jacket selected to provide infrared radiation.

14. An infrared heating element according to claim 1, wherein said heating source is designed as a heating wire of a resistance heater.

15. An infrared heating element according to claim 1, wherein said infrared-emitting layer comprises a metal oxide layer.

16. An infrared heating element according to claim 15, wherein said metal oxide layer comprises TiO₂.

17. An infrared heating element according to claim 16, wherein said TiO₂ layer has a thickness of between approximately 10 nm to 5 mm.

18. An infrared heating element according to claim 1, wherein said infrared-emitting layer is applied to said tubular metal jacket by plasma spraying.

19. An infrared heating element according to claim 1, wherein said tubular metal jacket comprises at least one selected from the group consisting of high-grade steel and Inconel®.

20. An infrared heating element according to claim 1, wherein said tubular metal jacket includes said infrared-emitting layer only in surface regions of said tubular metal jacket selected to provide infrared radiation.

21. A substrate heater type vacuum chamber for vacuum coating facilities, comprising:
a substrate; and
at least one infrared heating element positioned adjacent to said substrate, said infrared heating element comprising a heating source and a protective means, said protective means being designed as a tubular metal jacket, wherein said tubular metal jacket sheathes said heating source and includes at least a partial infrared-emitting layer;
wherein said infrared heating element is thermally decoupled from said substrate such that thermal conduction and thermal convection between said substrate and said infrared heating element are substantially prohibited.

22. A vacuum chamber according to claim 21, wherein said vacuum chamber includes a thermal insulator, said thermal insulator being adapted to thermally insulate said vacuum chamber such that said at least one infrared heating element is positioned between said substrate and said thermal insulator in a thermally decoupled manner.

23. A vacuum chamber according to claim 22, wherein said thermal insulator comprises a set of three successively arranged reflective radiation plates.

24. A vacuum chamber according to claim 22, wherein said at least one infrared heating element is positioned with its longitudinal axis parallel to said substrate.

25. A vacuum chamber according to claim 24, wherein said tubular metal jacket of said at least one infrared heating element comprises an infrared-emitting layer designed as a cylindrical longitudinal segment, and wherein said segment is positioned to face toward said substrate.

26. A vacuum chamber according to claim 25, wherein said infrared heating elements are spaced relative to said substrate such that the surface of said substrate is generally evenly exposed to infrared radiation.

27. A vacuum chamber according to claim 26, further including a substrate holder, said substrate being supported by said substrate holder.

28. A vacuum chamber according to claim 21, wherein said at least one infrared heating element is positioned with its longitudinal axis parallel to said substrate.

29. A vacuum chamber according to claim 21, wherein said tubular metal jacket of said at least one infrared heating element comprises an infrared-emitting layer designed as a cylindrical longitudinal segment, and wherein said segment is positioned to face toward said substrate.

30. A vacuum chamber according to claim 21, wherein said infrared heating elements are spaced relative to said substrate such that the surface of said substrate is generally evenly exposed to infrared radiation.

31. A vacuum chamber according to claim 21, further including a substrate holder, said substrate being supported by said substrate holder.

32. A substrate heater type vacuum chamber for vacuum coating facilities, comprising:
a substrate; and
at least one infrared heating element positioned adjacent to said substrate, said infrared heating element being thermally decoupled from said substrate such that thermal conduction and thermal convection between said substrate and said infrared heating element are substantially prohibited;
wherein said infrared heating element comprises a heating source and a protective means, said protective means being designed as a tubular metal jacket, wherein said tubular metal jacket sheathes said heating source and includes at least a partial infrared-emitting layer, and wherein said heating source is designed as a heating wire of a resistance heater and said tubular metal jacket is constructed of a metal having an emittance of between 0.1 to 0.4 and said infrared-emitting layer has an emittance of more than 0.7, and wherein said infrared-emitting layer comprises a metal oxide layer.
